(19) United States
(12) Patent Application Publication
(10) Pub. No.: US 2016/0232576 A1
(43) Pub. Date: Aug. 11, 2016

(54) Cardholder Affluence Measurement Method and Apparatus

(71) Applicant: MasterCard International Incorporated, Purchase, NY (US)

(72) Inventors: Rohit Chauhan, Somers, NY (US); Elisa Romm, Old Greenwich, CT (US); Bruce William MacNair, Stamford, CT (US)

(21) Appl. No.: 14/617,759

(22) Filed: Feb. 9, 2015

(51) Int. Cl. G06Q 30/02

(52) U.S. Cl. CPC G06Q 30/0269

(57) ABSTRACT

A system, method, and computer-readable storage medium configured to enable vendor recommendations using payment card transaction information.

### BACKGROUND

1. Field of the Disclosure

Aspects of the disclosure relate in general to financial services. Aspects include an apparatus, system, method and computer-readable storage medium to objectively measure affluence of a payment cardholder.

2. Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards provide the clients of a financial institution (“cardholders”) with the ability to pay for goods and services without the inconvenience of using cash. For example, traditionally, whenever travelers leave home, they carried large amounts of cash to cover journey expenditures, such as transportation, lodging, and food. Payment cards eliminate the need for carrying large amounts of currency. Moreover, in international travel situations, payment cards obviate the hassle of changing currency.

Payment cards are now ubiquitous in commerce. Typically, a payment card is electronically linked via a payment network to an account or accounts belonging to a cardholder. These accounts are generally deposit accounts, loan or credit accounts at an issuer financial institution. During a purchase transaction, the cardholder can present the payment card in lieu of cash or other forms of payment.

Payment networks process trillions of purchase transactions by cardholders.

Affluent cardholders are currently identified based on their total spending with their payment cards. For example, an individual spending $30,000 on a payment card will be considered more affluent when compared to an individual spending $15,000 on the payment card.

### SUMMARY

Embodiments include a system, device, method and computer-readable medium configured to objectively measure affluence of a payment cardholder.

In one embodiment, an apparatus is configured to categorize a specific merchant with a method. A processor extracts cardholder transactions from a database based on a merchant industry category of the specific merchant. The merchant industry category contains a plurality of merchants; the plurality of merchants includes the specific merchant. The database is stored on a non-transitory computer-readable storage medium. The processor calculates an average ticket value of the cardholder transactions at each of the plurality of merchants within the merchant industry category, and an average or mean ticket value of the cardholder transactions for the merchant industry category. The processor categorizes the specific merchant as either essential or luxury based on the average ticket value of the specific merchant and the average or the mean ticket value of the cardholder transactions for the merchant industry category. The category of the specific merchant is stored in the database on the non-transitory computer-readable storage medium.

In one embodiment, an apparatus comprises a non-transitory computer-readable storage medium and a processor. The non-transitory computer-readable storage medium is configured to store a database. The database contains a specific cardholder's payment card transactions, each payment card transaction being associated with a merchant. The processor is configured to extract the specific cardholder's payment card transactions from the database, categorize each of the specific cardholder's payment card transactions as essential spending or luxury spending based on the associated merchant, to calculate a total luxury spending by the cardholder, to calculate a total spending by the cardholder to calculate an affluence index of the specific cardholder by dividing the total luxury spending by the total spending, to categorize the affluence of the specific cardholder based on the affluence index of the specific cardholder and the total spending of the cardholder, and to store the affluence category of the specific cardholder in the database.

### BRIEF DESCRIPTION OF THE DRAWINGS

FIG. 1 illustrates an embodiment of a payment system configured to objectively measure affluence of a payment cardholder.

FIG. 2 depicts a block diagram of a payment network server configured to objectively measure affluence of a payment cardholder.

FIG. 3 flowcharts a method embodiment to categorize a merchant within a mixed industry category to objectively measure affluence of a payment cardholder.

FIG. 4 is a flowchart of a method embodiment to objectively measure affluence of a payment cardholder.

FIG. 5 is a chart illustrating the classification of categories in an industry category database.

FIG. 6 is a diagram correlating the ticket price of an item and the classification of categories in an industry category database.

FIG. 7 illustrates the affluence classification of a cardholder based on their spending and affluence index.

### DETAILED DESCRIPTION

One aspect of the disclosure includes the realization that measuring affluence based on total spending is an inadequate measure of affluence. While total spending may be a component of affluence, it does not adequately represent the affluence of cardholders that have high potential spending, but use payment cards sparingly. Using conventional methods of determining affluence based on total spending, an average individual spending $30,000 on a payment card is considered more affluent than the billionaire spending $15,000 on a payment card. However, such a result is misleading.

Another aspect of the disclosure includes the understanding that the type of cardholder spending is a major indicator of cardholder affluence. Suppose a cardholder spending $30,000 is a small home improvement contractor (and may not be affluent), while a cardholder spending $15,000 may be spending the entire amount on luxury items and services, such as golf clubs, jewelry stores, and cruise lines. Consequently, another aspect of the disclosure is the realization that spending on luxury products and services indicates higher affluence than spending on essential products and services.

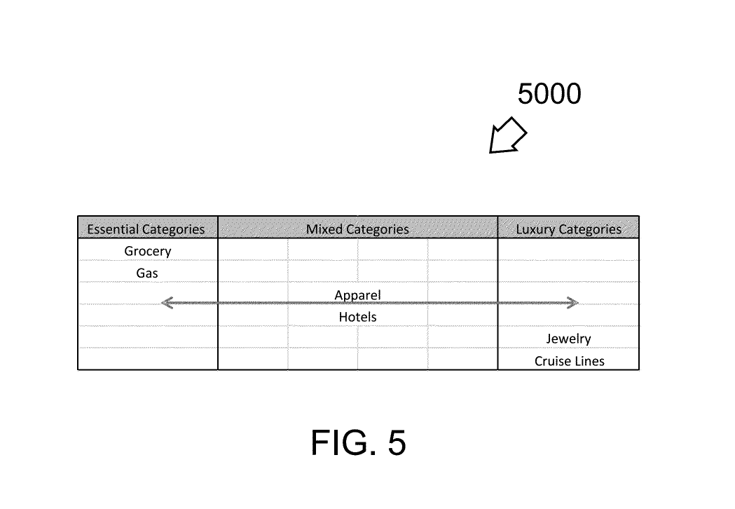

Generally, merchants may be categorized as luxury or essential spending based on either the industry category or the specificity of the merchant. FIG. 5 is a chart illustrating the classification of categories in an industry category database, constructed and operative in accordance with an embodiment of the present disclosure. For example, as shown in FIG. 5, the entire industry category of jewelry stores and cruise lines may be categorized as “luxury” spending, while the entire industry category gas stations and grocery stores may be categorized as “essential” spending. However, there are industry categories where a particular merchant may be on either side of the spectrum; spending in such industries are referred to as “mixed” spending. In a mixed industry category, some merchants may be essential, while others may be considered luxury. For example, in the hotel industry, a basic motel may be classified as “essential” spending, while an opulent resort may be classified as “luxury” spending. Similarly, apparel merchants may be essentially or luxury.

Embodiments of the present disclosure include a system, method, and computer-readable storage medium configured to objectively measure affluence of a payment cardholder.

For the purposes of this disclosure, a payment card transaction includes, but is not limited to, purchases made with credit cards, debit cards, prepaid cards, electronic checking, electronic wallet, or mobile device payments.

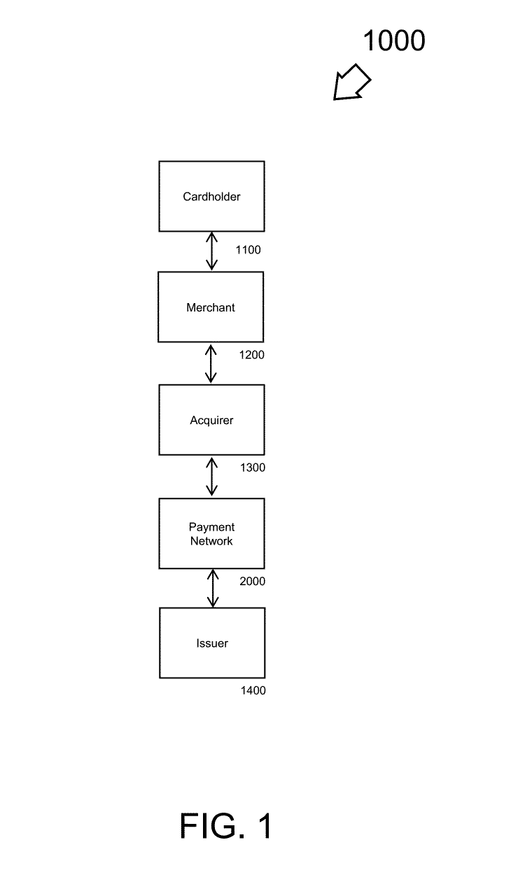

FIG. 1 illustrates an embodiment of a system 1000 configured to objectively measure affluence of a payment cardholder, constructed and operative in accordance with an embodiment of the present disclosure.

System 1000 includes a customer/cardholder 1100 using a payment card, mobile device, electronic wallet or other electronic payment device issued by an issuer 1400 for use at a merchant 1200. It is understood that a financial transaction at the merchant 1200 may occur in person at a “brick-and-mortar” location, or via a mobile communications network such as the Internet. Whenever a financial transaction occurs at a merchant 1200 using a payment card, the merchant 1200 communicates with an acquirer financial institution 1300 and payment network 2000 via an interbank network to determine the financial worthiness of the cardholder. Additionally, payment network 2000 may connect in turn to issuer bank 1400. Details and example methods of payment network 2000 are discussed below.

The merchant 1200 may be a store, restaurant, travel provider, merchant, or other service provider that offers goods or services to cardholders.

An issuer financial institution 1400 is the institution that provides the credit for the financial payment transaction. Issuer 1400 processes data (authorization requests) via the payment network 2000 and prepares the authorization-formatted response (approvals/declines).

Payment network 2000 is a payment network capable of processing payments electronically. An example payment network 2000 includes the network operated by MasterCard International Incorporated. Payment network 2000 includes the set of application program interface (API) functions, processes, and data that allow a financial transaction to take place. Additionally, payment network 2000 may analyze cardholder spending patterns to determine the affluence level of the cardholder.

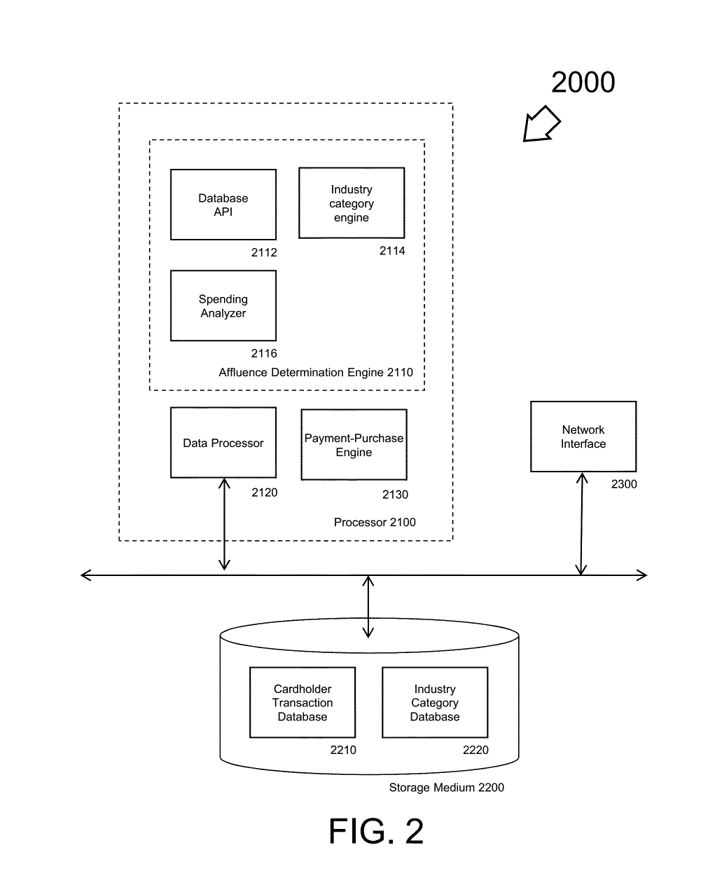

Embodiments will now be disclosed with reference to a block diagram of an exemplary payment network server 2000 of FIG. 2 configured to objectively measure affluence of a payment cardholder, constructed and operative in accordance with an embodiment of the present disclosure.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may communicate with and temporarily store information in Random Access Memory (RAM) (not shown).

As shown in FIG. 2, processor 2100 is functionally comprised of an affluence determination engine 2110, a payment-purchase engine 2130, and a data processor 2120.

Affluence determination engine 2110 may further comprise: a database API 2112, industry category engine 2114, and spending analyzer 2116.

Database API 2112 acts as an interface between affluence determination engine 2110 and various databases.

Industry category engine 2114 is the portion of the affluence determination engine 2110 that is configured to categorize merchant industries as either luxury, essential, or mixed spending. Industry category engine 2114 also communicates with spending analyzer 2116 to categorize the types of cardholder spending.

Spending analyzer 2116 analyzes cardholder spending, to compare volume and types of cardholder expenditures.

Payment-purchase engine 2130 performs payment and purchase transactions, and may do so in conjunction with the embodiments described herein.

Data processor 2120 enables processor 2100 to interface with storage medium 2200, network interface 2300 or any other component not on the processor 2100. The data processor 2120 enables processor 2100 to locate data on, read data from, and write data to these components.

These structures may be implemented as hardware, firmware, or software encoded on a computer readable medium, such as storage medium 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with merchant 1200, cardholder 1100, and/or issuer 1400.

Computer-readable storage medium 2200 may be a conventional read/write memory, such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a cardholder transaction database 2210, and industry category database 2220. Cardholder transaction database 2210 is configured to store the details of cardholder financial transactions. Industry category database 2220 stores the spending category types of merchants 1200.

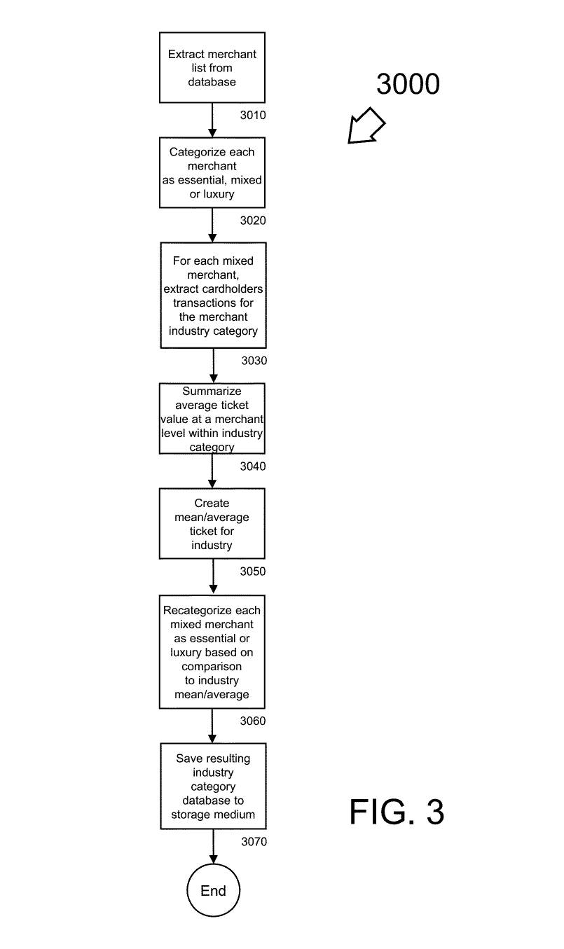

It is understood by those familiar with the art that one or more of these databases 2210-2220 may be combined in a myriad of combinations. The function of these structures may best be understood with respect to the flowchart of FIG. 3, as described below.

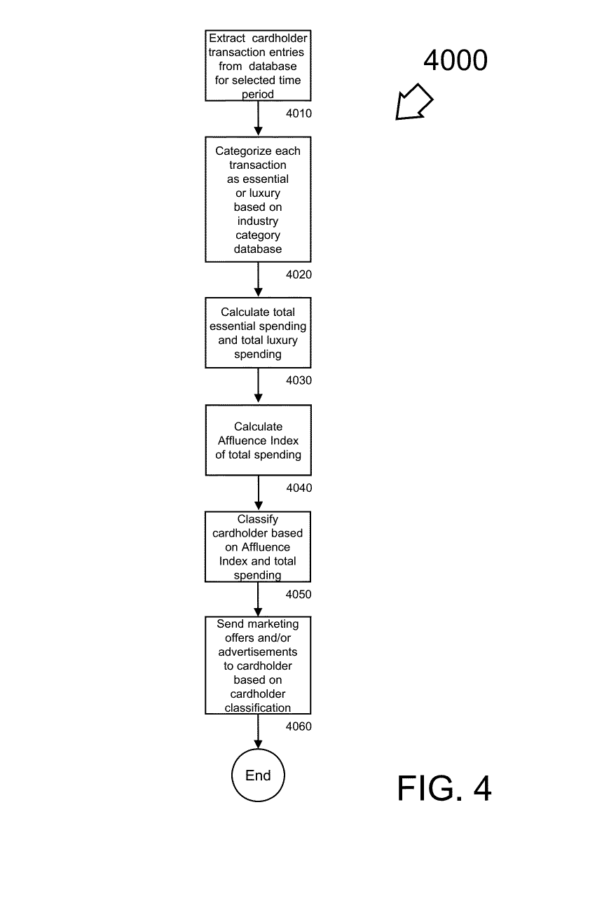

We now turn our attention to method or process embodiments of the present disclosure, FIGS. 3 and 4. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 flowcharts a payment network method 3000 embodiment to categorize a merchant within the “mixed” industry category to objectively measure affluence of a payment cardholder, constructed and operative in accordance with an embodiment of the present disclosure. In such an embodiment, an affluence determination engine 2110 takes a universe or subset of a payment network's financial transactions to determine whether spending at a particular merchant should be categorized as essential or luxury spending. This may be accomplished through matching the merchant's transactions and comparing the average ticket value at a merchant level within an industry category.

Initially database API 2112 extracts a merchant list from a cardholder transaction database 2210, block 3010. Typically, cardholder transaction database 2210 may be populated with a record of cardholder financial transactions by a payment network 2000 or issuer 1400. From this record of cardholder financial transactions, a list of merchants may be extracted. In alternate embodiments, a pre-prepared merchant list may be provided to the affluence determination engine 2110 by operators or managers of the affluence determination engine 2110.

Affluence determination engine 2110 categorizes each merchant into essential, luxury or mixed categories, block 3020. This categorization may be predetermined based on the industry. Industry categories are classified as “Essential” (such as groceries, and gasoline) or “Luxury” (such as Cruise Lines, and Jewelry) or “Mixed.” Merchants in the “Mixed” industry category could be tagged as “Essential” or “Luxury.” For example, the apparel industry category is mixed. Clothing from a mass-retailer may be categorized as “Essential” while clothing from a couture retailer could be considered “Luxury.”

All merchants in an industry that are tagged as “Essential” (such as groceries) will be assigned an “Essential” flag. Similarly all merchants in a “Luxury” industry category will be assigned a “Luxury” flag.

For a “Mixed” industry category, a year's worth of transactions for all merchants that belong to the “Mixed” merchant category are extracted and summarized. For each mixed merchant, the database API 2112 extracts cardholder transactions for the merchant industry category from the cardholder transaction database 2210, block 3030.

At block 3040, affluence determination engine 2110 summarizes the average ticket value at a merchant level within the industry category. This allows the affluence determination engine 2110 to determine the mean/average ticket value for the industry, block 3050.

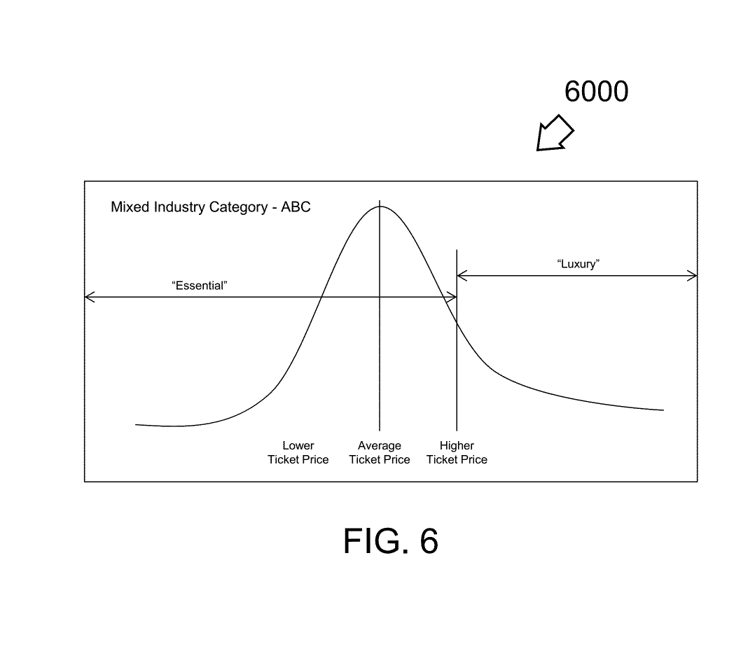

FIG. 6 is a diagram correlating the average ticket price at a merchant location and the classification of categories in an industry category database, constructed and operative in accordance with an embodiment of the present disclosure. In FIG. 6, the horizontal axis represents the ticket price of a purchase, while the vertical axis represents the number of sales made at the ticket price; the curve represents the distribution of sales at the ticket price. Using the comparison with the industry mean/average ticket value, each mixed merchant is re-categorized as either essential or luxury, block 3060. The distribution curve of FIG. 6 is then used along with the specific merchant statistics to tag a merchant as either “Essential” or “Luxury.” In some embodiments, the ticket value of luxury merchants is one standard deviation more expensive than the mean/average ticket value. In other embodiments, the ticket value of luxury merchants is three standard deviations more expensive than the mean/average ticket value.

For example, suppose for the apparel industry the average ticket is $50 (across all merchants) and the standard deviation is $30. Suppose for a box-store apparel dealer, the average ticket is $25. The box-store apparel dealer will be flagged as “Essential” as its ticket value is below the mean of $50. In contrast suppose a couture retailer has an average ticket value of $300, which is above the industry mean ticket ($50) and well over say two Standard Deviations of the distribution. The couture retailer will be flagged as “Luxury”

Note that the exercise of tagging a merchant as either “luxury” or “essential” is done once. The table/database is refreshed and kept up to date on a regular basis (e.g., quarterly or yearly)

The resulting reclassification of the merchant is saved into the industry category database 2220, block 3070.

Once all merchants are classified as either luxury or essential using process 3000, the resulting industry category database 2220 may be used to analyze cardholder spending to measure affluence of the payment cardholder. FIG. 4 is a flowchart of a method embodiment 4000 to objectively measure affluence of a payment cardholder, constructed and operative in accordance with an embodiment of the present disclosure.

In order to analyze a cardholder's affluence, at block 4010, the cardholder's payment transaction entries are extracted from a cardholder transaction database 2210 for a selected time period by the database API 2112. Generally, a year's worth of data is extracted as a representative period of time.

Each transaction is categorized by spending analyzer 2116 as either essential or luxury based on the industry category database 2220, block 4020.

The total essential spending and total luxury spending is calculated at block 4030.

At block 4040, an Affluence Index (AI) is calculated for each cardholder by dividing their luxury spending by total spending (luxury spending+essential spending). A higher Affluence Index (AI) indicates a higher level of affluence. Using the previous example, a cardholder who is a small home improvement contractor with $30,000 in spending may have an AI of 0.2, indicating mostly essential spending, and the payment card with $15,000 in spending may have an AI of 0.7, indicating mostly luxury spending.

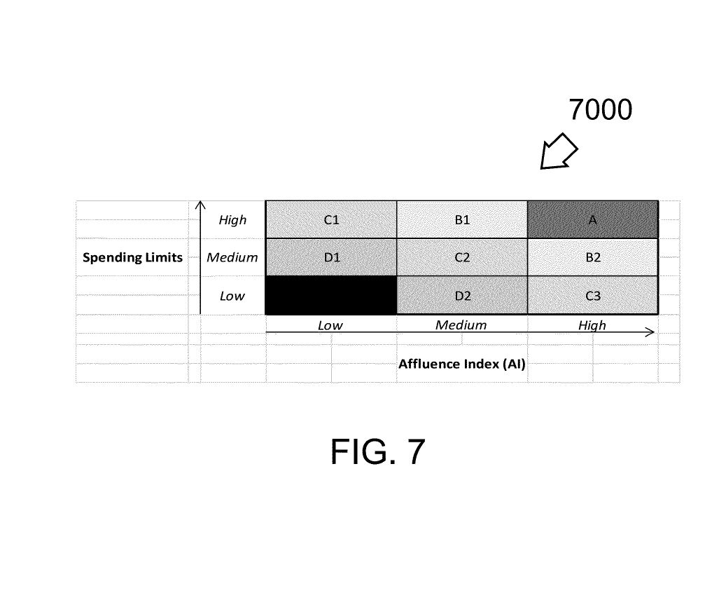

By itself, the Affluence Index is not sufficient to provide insights on what products and service might be most relevant to the consumer. For example, suppose cardholder Denise spends $1000 annually on luxury items and has an Affluence Index of 0.8. Cardholder Karin also has an Affluence Index of 0.8, but spends $10,000 annually on luxury items. While both cardholders have comparable Affluence Indices of 0.8, they may have very different needs with regards to products and services, which is reflected in the magnitude of their expenditures. At block 4050, a more holistic objective classification incorporates both magnitude of spent and Affluence Index to map cardholder affluence. An example of such mapping is shown in FIG. 7, which illustrates the affluence classification of a cardholder based on their spending and Affluence Index. As shown in FIG. 7, cardholders mapped in boxes A, B2 and C3 have a higher Affluence Index than those in B1, C1, C2, D1, and D2. Applying the above example, Denise may be categorized as a person in box C3—with a high Affluence Index, but low expenditures. Similarly, Karin may be categorized in a box with higher spending, such as B2 or A. Note that these designations are useful to compare cardholders with other cardholders. For marketing purposes, for example, a cardholder classified in B1 or B2 may be more desirable than a cardholder classified in D1 or D2. These designations may be adjusted for various levels of Affluence Index and level of expenditures.

At block 4060, the cardholder's Affluence Index is stored within the cardholder transaction database 2210 and used to send marketing offers and/or advertisements to the cardholder based on their cardholder classification. Such marketing offers may be presented electronically in the form of electronic mail, Short Message Service (SMS) messages, or banner advertisements. The marketing offers may also be presented in a more conventional method, such as mailings or other targeted advertisements.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method of categorizing a specific merchant, the method comprising:
extracting cardholder transactions from a database based on a merchant industry category of the specific merchant, the merchant industry category containing a plurality of merchants, the plurality of merchants including the specific merchant, the database being stored on a non-transitory computer-readable storage medium;
calculating an average ticket value of the cardholder transactions at each of the plurality of merchants within the merchant industry category with a processor;
calculating, with the processor, an average or mean ticket value of the cardholder transactions for the merchant industry category;
categorizing the specific merchant as either essential or luxury based on the average ticket value of the specific merchant and the average or the mean ticket value of the cardholder transactions for the merchant industry category;
storing the category of the specific merchant in the database on the non-transitory computer-readable storage medium.

2. The method of claim 1 wherein the merchant is categorized as luxury when the average ticket value of the specific merchant is one standard deviation more expensive than the average or the mean ticket value of the cardholder transactions for the merchant industry category.

3. The method of claim 1 wherein the merchant is categorized as luxury when the average ticket value of the specific merchant is two standard deviations more expensive than the average or the mean ticket value of the cardholder transactions for the merchant industry category.

4. A method of categorizing a specific cardholder, the method comprising:
extracting the specific cardholder's payment card transactions from a database for a specific time period, each payment card transaction being associated with a merchant, the database being stored on a non-transitory computer-readable storage medium;
categorizing, with a processor, each of the specific cardholder's payment card transactions as essential spending or luxury spending based on the associated merchant;
calculating, with the processor, a total luxury spending by the cardholder;
calculating, with the processor, a total spending by the cardholder;
calculating, with the processor, an affluence index of the specific cardholder by dividing the total luxury spending by the total spending;
categorizing the affluence of the specific cardholder, with the processor, based on the affluence index of the specific cardholder and the total spending of the cardholder.
storing the affluence category of the specific cardholder in the database stored on the non-transitory computer-readable storage medium.

5. The method of claim 4 wherein the categorizing each of the specific cardholder's payment card transactions as essential spending or luxury spending is further based on the associated merchant's status as essential or luxury.

6. The method of claim 4 wherein the specific time period is one year.

7. The method of claim 6 further comprising:
targeting the specific cardholder with advertisements based on the affluence category of the specific cardholder.

8. An apparatus comprising:
a non-transitory computer-readable storage medium configured to store a database, the database containing a specific cardholder's payment card transactions, each payment card transaction being associated with a merchant;
a processor configured to extract the specific cardholder's payment card transactions from the database, categorize each of the specific cardholder's payment card transactions as essential spending or luxury spending based on the associated merchant, to calculate a total luxury spending by the cardholder, to calculate a total spending by the cardholder to calculate an affluence index of the specific cardholder by dividing the total luxury spending by the total spending, to categorize the affluence of the specific cardholder based on the affluence index of the specific cardholder and the total spending of the cardholder, and to store the affluence category of the specific cardholder in the database.

9. The apparatus of claim 8 wherein the categorizing each of the specific cardholder's payment card transactions as essential spending or luxury spending is further based on the associated merchant's status as essential or luxury.

10. The apparatus of claim 8 wherein the specific time period is one year.

11. The apparatus of claim 10 further comprising:
targeting the specific cardholder with advertisements based on the affluence category of the specific cardholder.
